(19) United States
(12) Patent Application Publication
(10) Pub. No.: US 2026/0149676 A1
(43) Pub. Date: May 28, 2026

(54) METHOD FOR PROVIDING MESSAGE CHANGE INTERFACE, AND ELECTRONIC DEVICE SUPPORTING THE SAME

(71) Applicant: KAKAO CORP., Jeju-si (KR)

(72) Inventors: Jin Young YANG, Yongin-si (KR); Yu Jin HUH, Seongnam-si (KR); Dae Nyeon KIM, Seongnam-si (KR); Min Jeong YANG, Seongnam-si (KR)

(21) Appl. No.: 19/374,224

(22) Filed: Oct. 30, 2025

(30) Foreign Application Priority Data
Nov. 27, 2024 (KR) 10-2024-0171703

(51) Int. Cl. H04L 51/04; G06F 40/232; G06F 40/58

(52) U.S. Cl. CPC H04L 51/04; G06F 40/232; G06F 40/58

(57) ABSTRACT

Proposed are a method for providing a message change interface, and an electronic device supporting the same. The method may include receiving an input message through a chat room and providing a message change interface through the chat room, the message change interface being determined based on at least one piece of information from among information on the chat room and information associated with the input message when the at least one piece of information satisfies a preset criterion.

### CROSS-REFERENCE TO RELATED APPLICATION

This application claims priority to Korean Patent Application No. 10-2024-0171703 filed on Nov. 27, 2024, the entirety of which is incorporated herein by reference for all purposes.

### BACKGROUND

### Technical Field

The present disclosure relates to a method for providing a message change interface, and an electronic device supporting the same.

### Description of Related Technology

With the advancement of technology, various types of technologies are applied to messenger applications. Examples of various technologies applied to messenger applications include natural language processing (NLP) functions for understanding the semantics of messages, multimedia transmission functions, file transmission functions, and push notification functions. However, functions for efficient message change have not yet been applied to achieve efficient resource utilization of electronic devices or improvement in data management.

### SUMMARY

The present disclosure relates to a method for providing a message change interface for changing an input message received through a chat room, and an electronic device supporting the same.

In one general aspect of the present disclosure, a method for providing a message change interface by an electronic device includes: receiving an input message through a chat room; and providing a message change interface through the chat room, wherein the message change interface is determined based on at least one piece of information from among information on the chat room and information associated with the input message when the at least one piece of information satisfies a preset criterion.

According to one embodiment of the present disclosure, the message change interface may provide at least one of a spell check function for the input message and a translation function for the input message..

According to one embodiment of the present disclosure, providing the message change interface through the chat room may include: displaying a plurality of message change interfaces respectively corresponding to a plurality of functions for changing the input message through the chat room; and displaying, among the plurality of message change interfaces, a message change interface associated with at least one piece of information satisfying a preset criterion such that the message change interface is displayed in a manner distinguishable from other message change interfaces.

According to one embodiment of the present disclosure, providing the message change interface through the chat room may include displaying the message change interface in response to receiving an input message through the chat room.

According to one embodiment of the present disclosure, the information on the chat room may include at least one of (i) language type information of messages sent and received through the chat room and (ii) spelling error information of the messages sent and received through the chat room.

According to one embodiment of the present disclosure, the information on the chat room may include at least one of language type information of messages sent and received through the chat room and information on spelling errors in messages sent and received through the chat room by the electronic device.

According to one embodiment of the present disclosure, the information associated with the input message may include at least one of (i) the language type information of the input message, (ii) spelling error information of the input message, or (iii) keyword information of the input message.

According to one embodiment of the present disclosure, the method may further include further comprising, in response to receiving an interaction with the message change interface, displaying the changed input message through the chat room.

According to one embodiment of the present disclosure, the method may further include, in response to receiving an interaction with the message change interface, displaying a preview interface associated with a changed version of the input message on the chat room.

According to one embodiment of the present disclosure, providing the message change interface through the chat room may include displaying the message change interface in response to receiving an interaction with a menu switching interface displayed in one area of the chat room.

In another aspect of the present disclosure, an electronic device providing a message change interface includes a memory storing instructions, and a processor configured to execute the instructions to: receive an input message through a chat room; and provide a message change interface through the chat room, the message change interface being determined based on at least one piece of information from among information on the chat room and information associated with the input message when the at least one piece of information satisfies a preset criterion.

According to one embodiment of the present disclosure, a method for a server to provide a message change interface may include: identifying participation of an account of an electronic device in a chat room; determining a message change interface to be provided in the chat room, the message change interface being determined based on at least one piece of information from among information on the chat room and information associated with an input message of the electronic device when the at least one piece of information satisfies a preset criterion; and providing information on the message change interface through the chat room.

According to one embodiment of the present disclosure, the message change interface may provide at least one of a spell check function for the input message and a translation function for the input message..

According to one embodiment of the present disclosure, providing the information on the message change interface through the chat room may include: providing, through the chat room, a plurality of message change interfaces respectively corresponding to a plurality of functions for changing the input message; and providing, among the plurality of message change interfaces, a message change interface associated with at least one piece of information satisfying a preset criterion such that the message change interface is displayed in a manner distinguishable from other message change interfaces.

According to one embodiment of the present disclosure, the information on the chat room may include at least one of (i) language type information of messages sent and received through the chat room and (ii) spelling error information of the messages sent and received through the chat room.

According to one embodiment of the present disclosure, the method may further include performing a change on the input message in response to receiving an interaction with the message change interface.

According to one embodiment of the present disclosure, performing the change on the input message in response to receiving the interaction with the message change interface may include: determining a degree of change of the input message based on at least one of the language type information and tone information of messages sent and received through the chat room; and in response to receiving an interaction with the message change interface, performing a change on the input message based on the determined degree of change of the message.

In yet another aspect of the present disclosure, a server for providing a message change interface includes a memory storing instructions, and a processor configured to execute the instructions to: identify participation of an account of an electronic device in a chat room; determine a message change interface to be provided in the chat room, the message change interface being determined based on at least one piece of information from among information on the chat room and information associated with an input message of the electronic device when the at least one piece of information satisfies a preset criterion; and provide information on the message change interface through the chat room,

### BRIEF DESCRIPTION OF THE DRAWINGS

FIG. 1 illustrates an example of a network environment according to one embodiment of the present disclosure.

FIG. 2 is a flowchart illustrating a method for providing a message change interface by an electronic device according to one embodiment of the present disclosure.

FIG. 3 illustrates an example in which an electronic device provides a message change interface.

FIG. 4 illustrates another example in which an electronic device provides a message change interface.

FIG. 5 illustrates an example in which an electronic device provides an interface for activating a message change interface.

FIG. 6A and FIG. 6B illustrate an example in which an electronic device displays a message change interface.

FIGS. 7A to 7C illustrate an example in which an electronic device provides a preview interface for changing an input message.

FIGS. 8A and 8B illustrate an example in which an electronic device provides a message change interface according to one embodiment of the present disclosure.

FIGS. 9A and 9B illustrate an example in which an electronic device provides a message change interface according to one embodiment of the present disclosure.

FIGS. 10A to 10C illustrate an example in which an electronic device provides a function for changing an input message according to various embodiments of the present disclosure.

FIG. 11 is a flowchart illustrating a method for providing a message change interface by a server of the present disclosure.

### DETAILED DESCRIPTION

Hereinafter, embodiments disclosed in this specification will be described in detail with reference to the accompanying drawings. Regardless of reference numerals, like reference numerals designate like or similar elements, and repetitive descriptions thereof will be omitted for clarity. In describing the embodiments disclosed in this specification, detailed descriptions of well-known functions or constructions will not be provided when it is determined that such descriptions may unnecessarily obscure the gist of the embodiments disclosed herein.

Terms including ordinal numbers such as first, second, etc. may be used to describe various elements, but the elements are not limited by such terms. Such terms are used solely for the purpose of distinguishing one element from another.

Expressions in the singular shall also include the plural unless the context clearly dictates otherwise.

In this application, each step described may be performed in any order unless a particular causal relationship requires the steps to be performed in the listed order.

In this application, the terms such as “include” or “have” are intended to specify the presence of stated features, integers, steps, operations, elements, parts or combinations thereof, but should not be construed as precluding the presence or addition of one or more other features, integers, steps, operations, elements, parts or combinations thereof.

FIG. 1 illustrates an example of a network environment according to one embodiment of the present disclosure.

Hereinafter, the present disclosure will be described with reference to the accompanying drawings.

According to various embodiments, an electronic device 100 may be connected to a server 200 via a network. The network is not limited to a specific communication method and may support communication through various networks (e.g., a mobile communication network, wired or wireless Internet, or broadcasting network), as well as short-range wireless communication.

According to various embodiments, the electronic device 100 may include, for example, at least one of a smartphone, a tablet personal computer, a mobile phone, a video phone, an e-book reader, a desktop personal computer, a laptop personal computer, a netbook computer, a workstation, a server, a personal digital assistant (PDA), a portable multimedia player (PMP), an MP3 player, a mobile medical device, a camera, or a wearable device.

Referring to FIG. 1, according to various embodiments, the electronic device 100 may include a processor 110, a communication unit 120, an input unit 130, an output unit 140, and a memory 150. According to one embodiment, at least one of the components of the electronic device 100 may be omitted or other components may be additionally provided.

The processor 110 may control a number of hardware or software components connected to the processor 110 by driving an operating system or application program, and may perform various data processing and operations. The processor 110 may execute an application by controlling the overall operation of the communication unit 120, the input unit 130, the output unit 140, and the memory 150.

According to various embodiments, the processor 110 may activate a chat room in response to an interaction for requesting the creation of the chat room. For example, the processor 110 may display a chat room on the screen in response to receiving a selection interaction for activating the chat room. The interaction may include touching a touchscreen, clicking a mouse, typing on a keyboard, sound input from a microphone, image capture from a camera, or motion recognition from a motion sensor.

The chat room may be provided through the application to enable communication or information exchange between users of the electronic device 100 and an external electronic device (e.g., another electronic device) for sharing interests or hobbies. The application refers to a mobile-based application that is capable of providing chat functionality, voice functionality, video functionality, and the like between an account of the electronic device 100 that has downloaded the application and another account. In addition, the application may also refer to a desktop-based web application (e.g., a web-based messenger program) that is capable of providing chat functionality, voice functionality, video functionality, and the like between the account of the electronic device 100 and another account through access to the server 200 or an external server.

According to various embodiments, the electronic device 100 may register as a member of an application (e.g., a messenger application providing chat functionality, a desktop-based messenger program) and participate in a chat room using an account (e.g., an ID or an email account) registered with the application. The participation of the electronic device 100 in the chat room may be understood as participation of the account of the electronic device 100 in the chat room.

A chat room may provide chat functionality, voice functionality, video functionality, and the like between different electronic devices that have registered as members of the application. Chat rooms may include private chat rooms in which only the creator and participants invited by the creator may participate, and public chat rooms that may be joined through link information publicly posted on a bulletin board or the like, in addition to the creation and invitation of the chat rooms.

According to various embodiments, the processor 110 may receive an input message through a chat room. The reception of an input message by the processor 110 through a chat room may be understood as receiving a message input by a user of the electronic device 100 before sending the message to another account participating in the chat room. The processor 110 may display a message input via the electronic device 100 on the screen.

According to various embodiments, the processor 110 may provide a message change interface through a chat room. According to one embodiment, in response to receiving a message through the chat room, the processor 110 may display the message change interface either in real time or automatically. For example, the processor 110 may display a message input via the electronic device 100 in one area of the chat room, and display a message change interface in an adjacent area.

According to another embodiment, in response to receiving an input message through a chat room, the processor 110 may display a menu switching interface for displaying the message change interface. When the processor 110 receives an interaction from the electronic device 100 with the menu switching interface, the processor 110 may display the message change interface on the screen.

According to various embodiments, the message change interface may provide a function that allows the processor 110 to change an input message. According to one embodiment, the function for changing an input message may be performed based on a database or language model which includes data for supporting message change, the data stored in the memory 150 of the electronic device 100 and/or the memory 220 of the server 200.

According to another embodiment, the function for changing an input message may be performed through interworking with an external server (e.g., a cloud-based language model) and the electronic device 100 and/or the server 200. For example, the electronic device 100 and/or the server 200 may request a message change, and an external server may provide the electronic device 100 and/or the server 200 with a message change function through a natural language processing (NLP) API.

According to another additional embodiment, when a preset change criterion (e.g., a simple message change, message changes less than ten times, etc.) is satisfied, the processor 110 may perform a message change function. When the preset criterion is exceeded, a related functionality or user interface may be provided so that the message change function is performed through the server 200 or an external server.

The function for changing an input message, i.e., the message change function, may include a spell-checking function, a translation function, a tone change function, and a message summarization function, each for processing a message input by the user of the electronic device 100. The processor 110 may display, in the chat room, message change interfaces corresponding to respective functions for changing an input message. For example, the processor 110 may display, on the screen, a first message change interface for providing a spell-checking function, a second message change interface for providing a translation function, and a third message change interface for providing a tone change function.

According to various embodiments, when at least one piece of information from among information on the chat room and information associated with the input message satisfies a preset criterion, the message change interface may be determined based on the at least one piece of information.

According to one embodiment, the processor 110 may provide a message change interface providing a translation function when language type information of messages sent and received through a chat room includes a foreign language. The language type information of messages sent and received through the chat room may include information on whether messages sent and received between different accounts are in Korean, English, Japanese, Chinese, or the like. For example, if messages sent and received through a chat room are in Japanese, the processor 110 may determine, as an interface to be provided to the electronic device 100, a message change interface providing a translation function.

According to another embodiment, when the user's input message satisfies a preset spelling error rate (e.g., 30%, 50%, 70%, etc.) or a preset number of errors (e.g., two or more misspelled words, three or more misspelled words, etc.), the processor 110 may determine, as an interface to be provided to the electronic device 100, a message change interface providing a spelling correction function.

The communication unit 120 may establish communication between the electronic device 100 and an external electronic device. For example, the communication unit 120 may connect to a network through wireless or wired communication to communicate with the external electronic device (e.g., an external server) or the server 200.

The input unit 130 may serve as an interface that enables transmission of commands or data input from a user or another external device to other component(s) of the electronic device 100. In addition, the input unit 130 may output commands or data received from other components(s) of the electronic device 100 to the user or another external device. For example, the input unit 130 may be a touch screen module, a keyboard, a mouse, a button, a camera, a stylus, a microphone, and the like.

The electronic device 100 may receive a user's interaction through the input unit 130. The interaction refers to the input of information reflecting the user's selection or intention into the electronic device 100 by operating the input unit 130.

The output unit 140 may output various types of information. The output unit 140 may be a display, a touch screen, a speaker, a vibration generating device, a tactile generating device, and the like. The output unit 140 may, for example, display various types of contents (e.g., text, images, videos, icons, or symbols) to the user. According to various embodiments, the output unit 140 may be a device (e.g., a Bluetooth earphone) that receives and outputs signals through connection to the electronic device 100 via wired or wireless communication (e.g., short-range wireless communication such as Bluetooth).

The memory 150 serves as a storage medium and may store a plurality of application programs running on the electronic device 100, data for operating the electronic device 100, and commands. This memory may be provided as hardware in the form of various storage devices such as ROM, RAM, flash drives, hard drives, and the like, or in the form of web storage. In one embodiment, an application related to a messenger service (hereinafter referred to as ‘application’) may be stored in the memory 150.

According to various embodiments of the present disclosure, the server 200 may be implemented as a computer device or a plurality of computer devices that provide commands, codes, files, content, services, and the like. The server 200 may transmit and receive information through communication with the electronic device 100 via a network.

According to various embodiments, the server 200 may be a device that provides the messenger service to the electronic device 100. The electronic device 100 may be a device that utilizes the messenger service provided by the server 200. The messenger service may be a service that allows a plurality of users to send and receive messages with each other through a platform provided by the server 200. A message may refer to all types of transmittable data, including text, photos, videos, voice files, and emoticons.

According to various embodiments, the server 200 may be connected to the electronic device 100 via a network. The network is not limited to a specific communication method and may support communication through various networks (e.g., a mobile communication network, wired or wireless Internet, or broadcasting network), as well as short-range wireless communication.

According to various embodiments of the present disclosure, the server 200 may be implemented as a computer device or a plurality of computer devices that provide commands, codes, files, content, services, and the like. According to one embodiment, the server 200 may be an electronic device capable of transmitting and receiving information through communication with the electronic device 100 via a network. For convenience of explanation, the server 200 is described as a single server, but may include a plurality of servers that provide different functions or services.

According to various embodiments, when the electronic device 100 is required to perform a predetermined function or service automatically or in response to a request, the electronic device 100 may, instead of or in addition to executing the function or service, request the server 200 to perform at least part of the related function. The server 200 may execute a requested function or an additional function and transmit the result to the electronic device 100. The electronic device 100 may process the result as received or with additional processing to provide the requested function or service. For example, cloud computing, distributed computing, or client-server computing technologies may be used.

The server 200 may include a processor 210, a memory 220, and a communication unit 230. The processor 210 may control the overall operation of the memory 220 and the communication unit 230. According to various embodiments of the present disclosure, the memory 220 serves as a storage medium and may store a plurality of application programs running on the server 200, data for the operation of the server 200, and commands. In one embodiment, the memory 220 may be provided as hardware in the form of various storage devices such as ROM, RAM, flash drives, hard drives, and the like, or in the form of web storage. The communication unit 230 may communicate with the electronic device 100 via a network in a wired or wireless manner.

According to various embodiments, the server 200 may provide various applications to the electronic device 100. According to one embodiment, an external device (e.g., the server 200, an external server linked to the server 200, a third-party server, etc.) may provide related functionality or interface, so that the electronic device 100 or an external terminal can download various applications that provide chat functionality, voice call functionality, and/or map service functionality. For example, the application may include a preloaded application or a third-party application downloadable from the server 200.

According to various embodiments, the processor 210 may identify an account participating in a plurality of chat rooms. For example, the processor 210 may identify the number of chat rooms in which an account of the electronic device 100 is participating, the types of chat rooms, or other accounts of other devices participating in the chat rooms.

According to various embodiments, the processor 210 may determine a message change interface to be provided to the chat room. According to one embodiment, when information on the chat room satisfies a preset criterion, the processor 210 may determine a message change interface associated with the information on the chat room. For example, when language type information of messages sent and received through the chat room includes a foreign language (e.g., Korean, Japanese, Chinese, etc.), the processor 210 may determine, as an interface to be provided to the chat room, a message change interface providing a translation function. The foreign language may refer to a language (e.g., Korean, Japanese, etc.) other than the language (e.g., English) designated by the user of the electronic device 100 as the default language of the chat room.

In another example, when the language type information of messages sent and received through a first chat room does not include a foreign language, the processor 210 may not provide a message change interface providing a translation function, whereas when the language type information of messages sent and received through a second chat room includes a foreign language, the processor 210 may provide the message change interface providing a translation function. In another additional example, when the language type information of messages sent and received through the first chat room includes Japanese, the processor 210 may provide a message change interface providing a translation function from English to Japanese, whereas when the language type information of messages sent and received through the second chat room includes Korean, the processor 210 may provide the message change interface providing a translation function from English to Korean. In yet another example, when the language type information of messages sent and received through a chat room includes a foreign language, the processor 210 may provide a message change interface including an interface that enables selection of a translation from English to Japanese, a translation from English to Korean, a translation from English to Chinese, and the like.

According to one embodiment, when the information associated with a message input by the user of the electronic device 100 satisfies a preset criterion, the processor 210 may provide a related functionality or user interface so that a message change interface for changing the input message to the electronic device 100 is determined. For example, the processor 210 may provide a related functionality or user interface so that a message change interface providing a spelling correction function is displayed on the electronic device 100 when a message input by the user of the electronic device 100 satisfies a preset spelling error rate (e.g., 30%, 50%, 70%, etc.) or a preset number of errors (e.g., two or more misspelled words, three or more misspelled words, etc.). In another example, when a message input by the user of the electronic device 100 includes preset keyword information (e.g., #spelling, #translation, #tone, etc.), the processor 210 may provide a related functionality or user interface so that a message change interface corresponding to the keyword information is displayed on the electronic device 100.

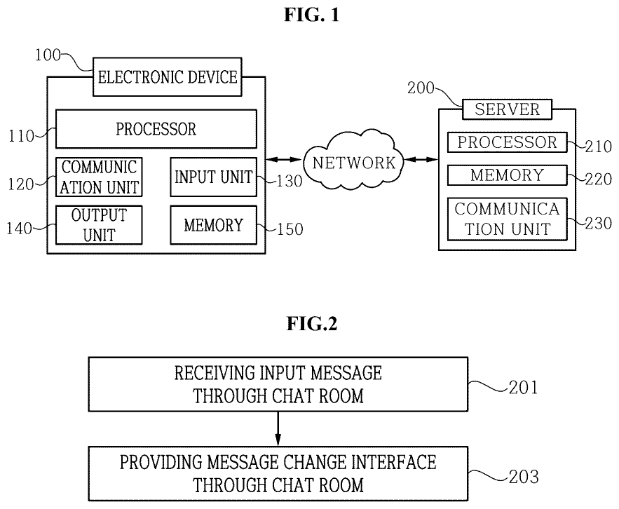

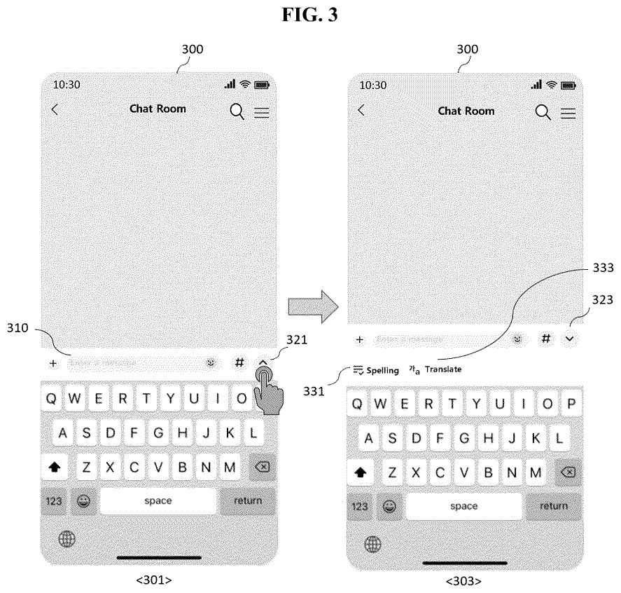

FIG. 2 is a flowchart illustrating an example in which the electronic device 100 provides a message change interface according to one embodiment of the present disclosure.

In operation 201, the electronic device 100 may receive an input message through a chat room. The electronic device 100 may receive a message (e.g., a text message, an emoticon, a voice message, a video message, etc.) input by the user through a keyboard interface. The electronic device 100 may not transmit the message to other accounts participating in the chat room, without an additional interaction for sending the message (e.g., an interaction with the send interface).

In operation 203, the electronic device 100 may provide a message change interface through a chat room. The message change interface may provide a function for changing a message.

According to various embodiments, the message change interface may be determined based on at least one piece of information from among information on the chat room and information associated with an input message when the at least one piece of information satisfies a preset criterion.

The information on the chat room may include at least one of (i) language type information of messages sent and received through the chat room and (ii) spelling error information of such messages.

According to one embodiment, the electronic device 100 may identify language type information of messages sent and received through the chat room and determine whether the identified language type information matches language type information of a message input by the user of the electronic device 100. For example, when the language type information of the messages sent and received through the chat room corresponds to Korean and the language type information of a message input by the user corresponds to English, the electronic device 100 may provide a message change interface providing a translation function (e.g., English-Korean translation). In another example, when the language type information of the messages sent and received through the chat room corresponds to Korean and the language type information of a message input by the user corresponds to English, the electronic device 100 may change an English message input by the user into Korean in real time or automatically. In yet another example, the electronic device 100 may change an input English message into Korean and then display, through a chat room, an additional message or interface (e.g., a pop-up message or pop-up interface) such as “Would you like to change it into Korean?”.

In yet another example, the electronic device 100 may display a message change interface providing a translation function, and, in response to receiving an interaction with the displayed message change interface, display a plurality of translation interfaces respectively configured to provide translation between different languages (e.g., English—Korean, English—Japanese, English—Chinese, etc.). In response to receiving an interaction with one of the plurality of translation interfaces, the electronic device 100 may provide a translation of the English message input by the user according to the received interaction.

According to various embodiments, when messages sent and received through a chat room are in a plurality of languages, the electronic device 100 may determine predominant language type information of the chat room. For example, a first account participating in the chat room may send messages in English, a second account may send messages in Korean, and a third account may send messages in Japanese. In the above example, the electronic device 100 may determine the predominant language type of the chat room (e.g., English, Korean, etc.) based on the language type information of messages most frequently sent and received through the chat room within a preset period (e.g., 4 hours, 3 days, 1 week, etc.). The electronic device 100 may provide a translation function for a message input by the user of the electronic device 100 based on the determined predominant language type information.

According to one embodiment, the electronic device 100 may identify spelling error information of messages sent and received through a chat room. According to one embodiment, the electronic device 100 may identify spelling error information of messages sent and received through a chat room for a preset period of time (e.g., 4 hours, 1 day, 1 week, etc.). For example, when spelling errors in a message input by the user of the electronic device 100 among messages sent and received through a chat room satisfy a preset spelling error rate (e.g., 30%, 50%, 70%, etc.) or a preset number of errors (e.g., two or more misspelled words, three or more misspelled words, etc.), the electronic device 100 may provide a message change interface providing a spelling correction function.

The information associated with the input message may include at least one of (i) language type information of the input message, (ii) spelling error information included in the input message, or (iii) keyword information included in the input message.

According to one embodiment, the electronic device 100 may identify language type information of an input message through the chat room and determine whether the identified language type information matches default language type information set by the user. For example, if language type information of an input message is English and default language type information set by the user is Japanese, the electronic device 100 may provide a message change interface providing a translation function (e.g., English-Japanese translation). In yet another example, when language type information of an input message is English and default language type information set by the user is Japanese, the electronic device 100 may automatically or in real time change the English input message into Japanese. In yet another example, the electronic device 100 may change an input English message into Japanese and then display an additional message or interface (e.g., a pop-up message or a pop-up interface) such as “Would you like to change it into Japanese?” through the chat room.

According to one embodiment, the electronic device 100 may identify spelling error information of an input message received through a chat room. For example, when spelling errors in the input message satisfies a preset spelling error rate (e.g., 30%, 50%, 70%, etc.) or a preset number of errors (e.g., two or more misspelled words, three or more misspelled words, etc.), the electronic device 100 may provide a message change interface providing a spelling correction function.

According to various embodiments, the electronic device 100 may determine whether preset keyword information is included in the user's input message. According to one embodiment, when the input message includes preset keyword information (e.g., spelling, translation, tone change, etc.), the electronic device 100 may display a message change interface corresponding to the keyword information. For example, when a message input by the user, such as “Should I translate the message?” or “#translation,” contains preset keyword information “translation,” the electronic device 100 may display a message change interface providing a translation function.

According to various embodiments, the electronic device 100 may display a plurality of message change interfaces on the screen. For example, among the plurality of message change interfaces, a first message change interface may provide a spell check function for a message, and a second message change interface may provide a translation function. In the above example, the electronic device 100 may display the first message change interface and the second message change interface together.

In another example, the electronic device 100 may display on the screen only one of the first and second message change interfaces, the one that is associated with at least one piece of information satisfying a preset criterion. In yet another example, the electronic device 100 may display the first message change interface and the second message change interface together such that one message change interface associated with at least one piece of information satisfying a preset criterion is displayed in a manner distinguishable from the other message change interface.

According to one embodiment, the electronic device 100 may display a plurality of message change interfaces when both information on the chat room and information associated with an input message satisfy a preset criterion. For example, when language type information of messages sent and received through a chat room corresponds to Korean and spelling errors in a message input by a user satisfies a preset spelling error rate (e.g., 30%, 50%, 70%, etc.), the electronic device 100 may display together the first message change interface, providing a translation function (e.g., English—Korean translation), and a second message change interface, providing a spelling correction function.

According to another embodiment, when the information on the chat room and the information associated with an input message satisfy a preset criterion, the electronic device 100 may display only one message change interface among a plurality of message change interfaces corresponding to the preset criterion. For example, the electronic device 100 and/or the server 200 may determine one message change interface among a plurality of message change interfaces based on a preset priority. The preset priority may be a priority set by the electronic device 100 and/or the server. For example, when the language type information of messages sent and received through a chat room is a language other than Korean (e.g., Japanese, Spanish, Chinese, etc.) and a preset spelling error rate is 30% or higher, the electronic device 100 may give a highest priority to the translation function for the input message and display only the first message change interface providing the translation function.

In another example, when language type information of messages sent and received through a chat room is Korean and a preset spelling error rate is 30% or higher, only the second message change interface providing a spelling correction function may be displayed. In yet another example, when language type information of messages sent and received through the chat room is a foreign language (e.g., Korean, Japanese, etc.) and a preset spelling error rate is 50% or higher, the electronic device 100 may give a highest priority to spelling correction and display only the second message change interface providing the spelling correction function.

According to one embodiment, in response to receiving an interaction with the message change interface, the electronic device 100 may display a changed message through the chat room. For example, in response to receiving an interaction with a message change interface providing a translation function for an English message input by the user, the electronic device 100 may change the English message into a foreign language (e.g., Korean, Japanese, Chinese, etc.). In another example, in response to receiving an interaction with the message change interface providing a spelling correction function for a message input by the user, the electronic device 100 may change the input message into a spelling-corrected message where any spelling errors in the input message have been corrected.

According to one embodiment, in response to receiving an interaction with the message change interface, the electronic device 100 may display, through a chat room, a preview interface associated with a changed version of an input message. For example, in response to receiving an interaction with a message change interface providing a translation function for an English message input by the user, the electronic device 100 may display a preview interface that includes a message changed into a foreign language (e.g., Korean, Japanese, Chinese, etc.). In another example, in response to receiving an interaction with a message change interface providing a spelling correction function for a message input by the user, the electronic device 100 may display a message change interface displaying a spelling-corrected message.

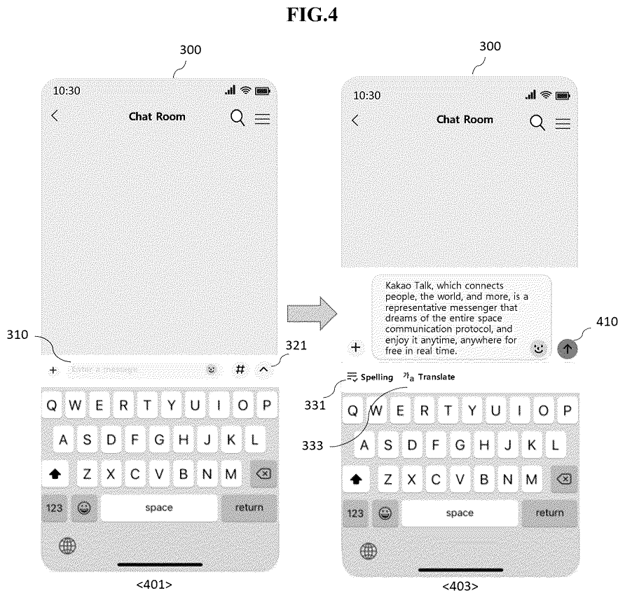

FIG. 3 illustrates an example in which the electronic device 100 provides a message change interface.

Referring to 301 of FIG. 3, the electronic device 100 may display a chat room 300 on a screen. According to one embodiment, the electronic device 100 may display the chat room 300 on the screen in response to an interaction for activating the chat room 300. The chat room 300 may include an input interface 310 for entering a message and a first menu switching interface 321.

Referring to 303 of FIG. 3, in response to receiving an interaction with the first menu switching interface 321, the electronic device 100 may switch the first menu switching interface 321 to a second menu switching interface 323 and display a first message change interface 331 and a second message change interface 333 on the screen. The first message change interface 331 may be an interface that supports a function for correcting spelling errors in a message. The second message change interface 333 may be an interface that provides a function for changing language type information of an input message (e.g., Korean, English, Japanese, Arabic, Chinese, etc.).

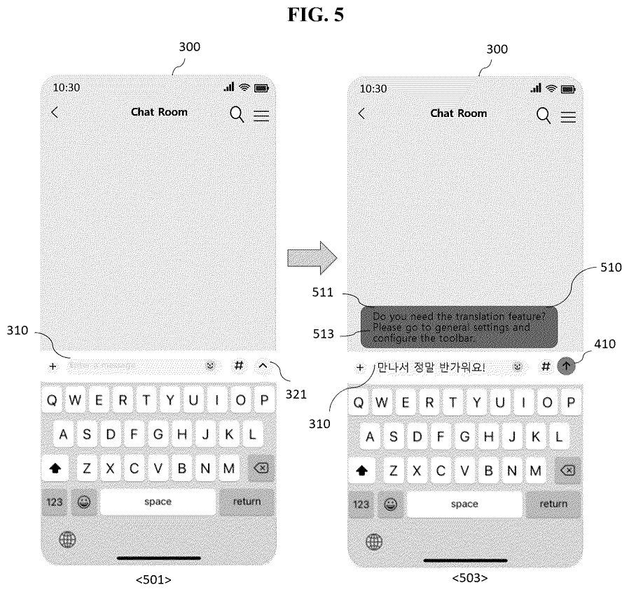

FIG. 4 illustrates another example in which the electronic device 100 provides a message change interface.

Referring to 401 of FIG. 4, the electronic device 100 may display a chat room 300 on a screen. Referring to 403 of FIG. 4, in response to receiving an input message through an input interface 310, the electronic device 100 may change the first menu switching interface 321 to a send interface 410 and display a first message change interface 331 and a second message change interface 333 on the screen. The send interface 410 may provide a function to send a message input by the user (e.g., Kakao Talk, which connects people, the world, and more, is a representative messenger that dreams of the entire space communication protocol, and enjoy it anytime, anywhere for free in real time.) to another account participating in the chat room.

FIG. 5 illustrates an example in which the electronic device 100 provides an interface for activating a message change interface.

Referring to 501 of FIG. 5, the electronic device 100 may display a chat room 300 on the screen. Referring to 503 of FIG. 5, in response to receiving an input message (e.g., Korean language text indicating “very nice to meet you!”) through an input interface 310, the electronic device 100 may change the first menu switching interface 321 to a send interface 410 and display a pop-up interface 510.

According to one embodiment, the pop-up interface 510 may include information related to the activation of the message change interface by an account of the electronic device 100. For example, the pop-up interface 510 may include information 511 on a message change function and a settings-link interface 513.

According to one embodiment, the information 511 on the recommended change function may be determined based on the message input by the user. For example, if the user's input message is in a foreign language (e.g., Korean, Japanese, Chinese, etc.), the electronic device 100 may include text information on a ‘translation function’ in the information 511 on the message change function. In the above example, the electronic device 100 may include text information such as “Do you need a ‘translation function’?” in the pop-up interface 510. In another example, when the user's input message has any spelling errors, the electronic device 100 may include text information on the ‘spelling correction function’ in the information 511 on the message change function. In the above example, the electronic device 100 may include text information such as “Do you need a ‘spelling correction function’?” in the pop-up interface 510.

According to another additional embodiment, the information 511 on the recommended change function may be determined as a preset default message. For example, information on the recommended change function 511 may include predefined text information such as “Do you need a spelling or translation function?”

According to one embodiment, the settings-link interface 513 may include link information that supports a function for configuring a message change interface. For example, in response to receiving an interaction with the settings-link interface 513, the electronic device 100 may display a settings interface for configuring or activating a message change interface. When the electronic device 100 activates the message change interface through the settings interface, when a selection interaction is made on the first menu switching interface 321, or when a message is received through the input interface 310, the electronic device 100 may display the message change interface on the screen.

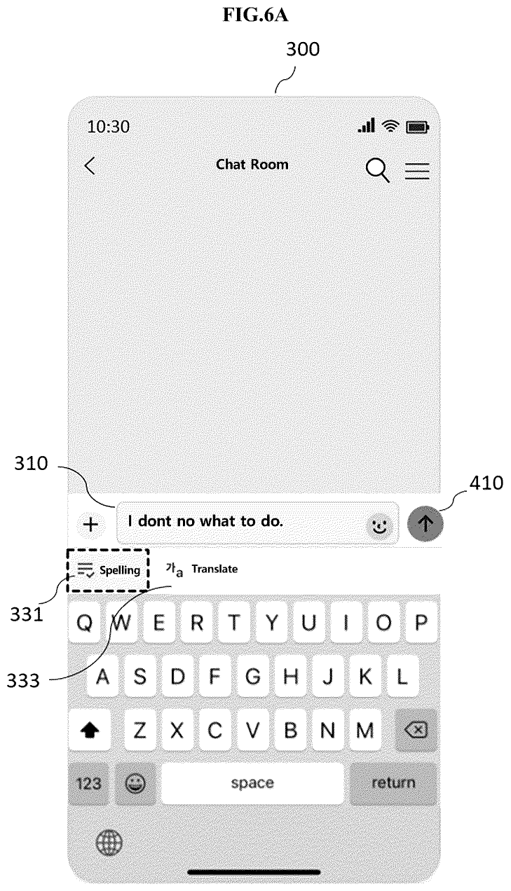

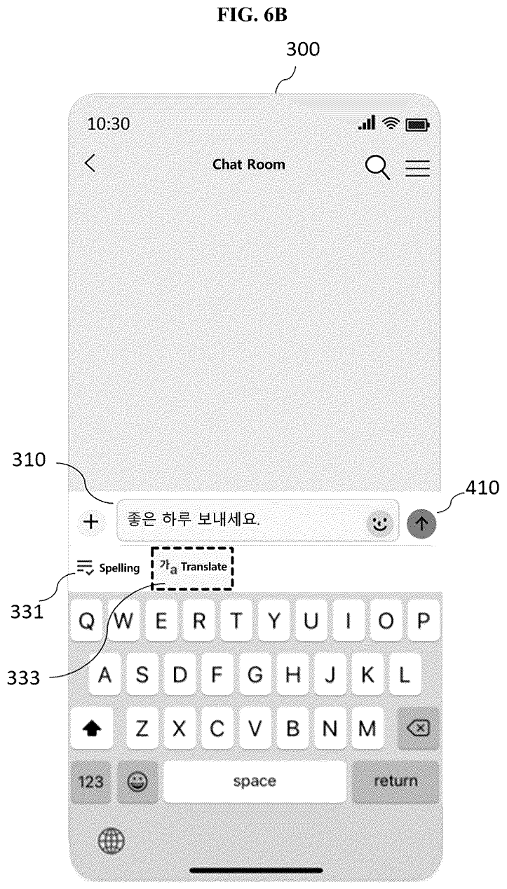

FIG. 6A and FIG. 6B illustrate an example in which the electronic device 100 displays a message change interface.

Referring to FIG. 6A, in response to receiving an input message, the electronic device 100 may display a first message change interface 331 and a second message change interface 333 on the screen. For example, the first message change interface 331 may provide a spelling correction function, and the second message change interface 333 may provide a translation function.

According to one embodiment, when information associated with an input message satisfies a preset criterion, the electronic device 100 may determine one message change interface among a plurality of message change interfaces 331 and 333 based on the information associated with the input message. For example, when the user's input message (e.g., “I dont no what to do”) satisfies a preset spelling error rate (e.g., 30%, 50%, 70%, etc.) or a preset number of errors (e.g., two or more misspelled words, three or more misspelled words, etc.), the electronic device 100 may determine the first message change interface 331, which provides a spelling correction function, among the plurality of message change interfaces 331 and 333.

According to one embodiment, the electronic device 100 may display only the determined first message change interface 331 on the screen. According to another embodiment, the electronic device 100 may display the first message change interface 331 together with the second message change interface 333 such that the first message change interface 331 is displayed in a manner distinguishable from the second message change interface 333. For example, the electronic device 100 may display the first message change interface 331 in a different color, font, or size, or in an emphasized manner compared to the second message change interface 333.

Referring to FIG. 6B, in response to receiving an input message, the electronic device 100 may display the first message change interface 331 and the second message change interface 333 on the screen.

According to one embodiment, when at least one piece of information from among the information on the chat room and the information associated with the input message satisfies a preset criterion, the electronic device 100 may determine one message change interface among a plurality of message change interfaces 331 and 333 based on the at least one piece of information.

For example, when language type information of messages sent and received through a chat room 300 includes a foreign language (e.g., Korean, Japanese, Chinese, etc.), the electronic device 100 may determine the second message change interface 333 providing a translation function among the plurality of message change interfaces 331 and 333. In another example, when the user's input message (e.g., Korean language text indicating “have a great day!”) does not correspond to default language type information (e.g., English) set by the account of the electronic device 100, the electronic device 100 may determine the second message change interface 333 providing a translation function among the plurality of message change interfaces 331 and 333.

According to one embodiment, the electronic device 100 may display only the determined second message change interface 333 on the screen. According to another embodiment, the electronic device 100 may display the second message change interface 333 together with the first message change interface 331 such that the second message change interface 333 is displayed in a manner distinguishable from the first message change interface 331. For example, the electronic device 100 may display the second message change interface 333 in a different color, font, or size, or in an emphasized manner compared to the first message change interface 331.

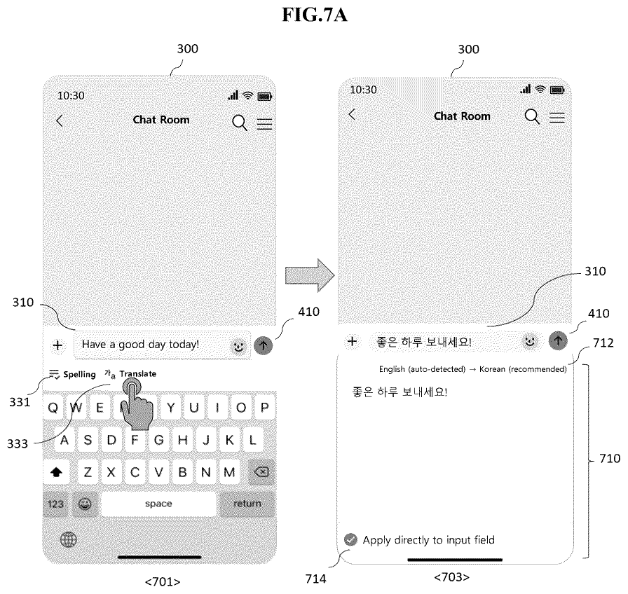

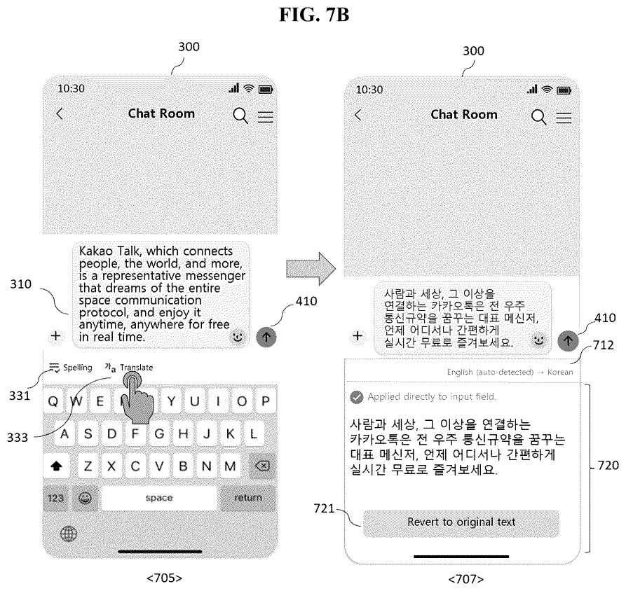

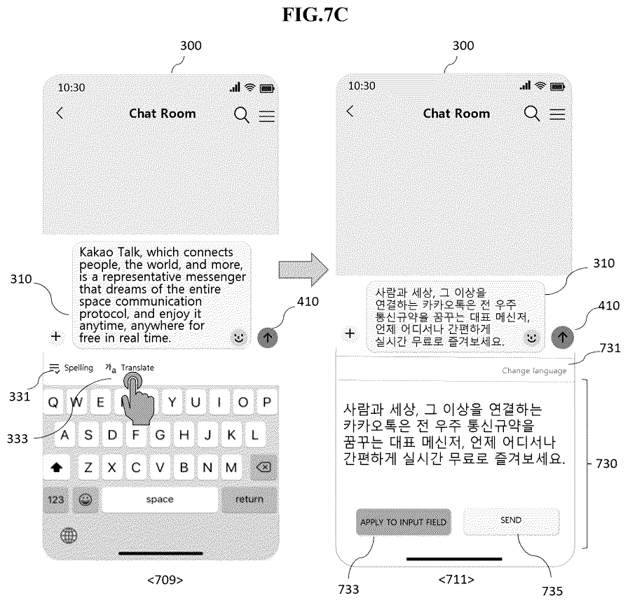

FIGS. 7A to 7C illustrate an example in which the electronic device 100 provides a preview interface for changing an input message.

Referring to 701 of FIG. 7A, the electronic device 100 may display a message input by the user (e.g., “Have a good day today!”) on the screen. In response to receiving the input message, the electronic device 100 may display a first message change interface 331 and a second message change interface 333 on the screen. The electronic device 100 may display, on the screen, a send interface 410 that provides a function for sending the input message.

Referring to 703 of FIG. 7A, the electronic device 100 may display a preview interface 710 in one area of the chat room. According to one embodiment, the preview interface 710 may include recommended message change information 712 and an apply interface 714.

The recommended message change information 712 may include language type information (e.g., English) of the input message received from the user and target language type information (e.g., Korean). According to one embodiment, the target language type information (e.g., Korean) may be determined based on information on the chat room. For example, when Korean is included in language type information of messages previously sent and received through the chat room, the electronic device 100 and/or server 200 may determine Korean as the highest-priority recommended target language type among foreign languages for which a translation function is provided. In another example, when the number of Korean messages among messages previously sent and received through the chat room exceeds a preset frequency (e.g., 5 times or more, 10 times or more), the electronic device 100 and/or server 200 may determine Korean as the highest-priority recommended target language type among foreign languages for which a translation function is provided.

In yet another example, when the number of Korean messages among messages sent by the account of the electronic device 100 through the chat room exceeds a preset frequency (e.g., 5 times or more, 10 times or more), the electronic device 100 and/or the server 200 may determine Korean as the highest-priority recommended target language type among the foreign languages for which a translation function is provided. In yet another example, when a Korean message is included in messages sent by the account of the electronic device 100 through the chat room within a preset period (e.g., within the last week, within the last 3 days, within the last 10 seconds, etc.), the electronic device 100 and/or server 200 may determine Korean as the highest-priority recommended target language type among foreign languages for which a translation function is provided.

The apply interface 714 may provide a function for selecting whether to display a changed message in real time through the input interface 310. For example, in response to receiving a selection interaction for the apply interface 714, the electronic device 100 may display a Korean language message translated from “Have a good day today!” on the input interface 310. In another example, in response to receiving a release interaction for the apply interface 714, the electronic device 100 may display the translated Korean language message only within one area of the preview interface 710.

Referring to 705 of FIG. 7B, the electronic device 100 may display a message input by the user (e.g., Kakao Talk, which connects people, the world, and more, is a representative messenger that dreams of the entire space communication protocol, and enjoy it anytime, anywhere for free in real time.) on the screen. In response to receiving the input message, the electronic device 100 may display a first message change interface 331 and a second message change interface 333 on the screen. The electronic device 100 may display, on the screen, a send interface 410 that provides a function for sending the input message.

Referring to 707 of FIG. 7B, the electronic device 100 may display a preview interface 720 in one area of the chat room. According to one embodiment, the preview interface 720 may include recommended message change information 712 and an original text restoration interface 721. According to one embodiment, in response to receiving an interaction with the original text restoration interface 721, the electronic device 100 may revert the changed message (e.g., Korean language text indicating an original message “Kakao Talk, which connects people, the world, and more, is a representative messenger that dreams of the entire space communication protocol, and enjoy it anytime, anywhere for free in real time”) to the original message.

Referring to 709 of FIG. 7C, the electronic device 100 may display a message input by the user (e.g., Kakao Talk, which connects people, the world, and more, is a representative messenger that dreams of the entire space communication protocol, and enjoy it anytime, anywhere for free in real time.) on the screen. In response to receiving an the input message, the electronic device 100 may display a first message change interface 331 and a second message change interface 333 on the screen. The electronic device 100 may display, on the screen, a send interface 410 that provides a function for sending the input message.

Referring to 711 of FIG. 7C, the electronic device 100 may display a preview interface 730 in one area of the chat room. According to one embodiment, the preview interface 730 may include a language switching interface 731, an apply interface 733, and a send interface 735.

According to one embodiment, the language switching interface 731 may provide a function for changing a message input by the user into various languages. For example, in response to receiving a selection interaction with the language switching interface 731, the electronic device 100 may display a translation interface that supports a translation function, such as English—Korean, Korean—English, English—Japanese, Japanese—English, and Japanese—Korean translations, in the chat room. In response to receiving an interaction with one of the displayed interfaces, the electronic device 100 may provide a translation for the input message.

According to one embodiment, in response to receiving an interaction with the apply interface 733, the electronic device 100 may display a translated message on the input interface 310. According to one embodiment, the send interface 735 may provide a function for sending an input message, similarly to the send interface 410.

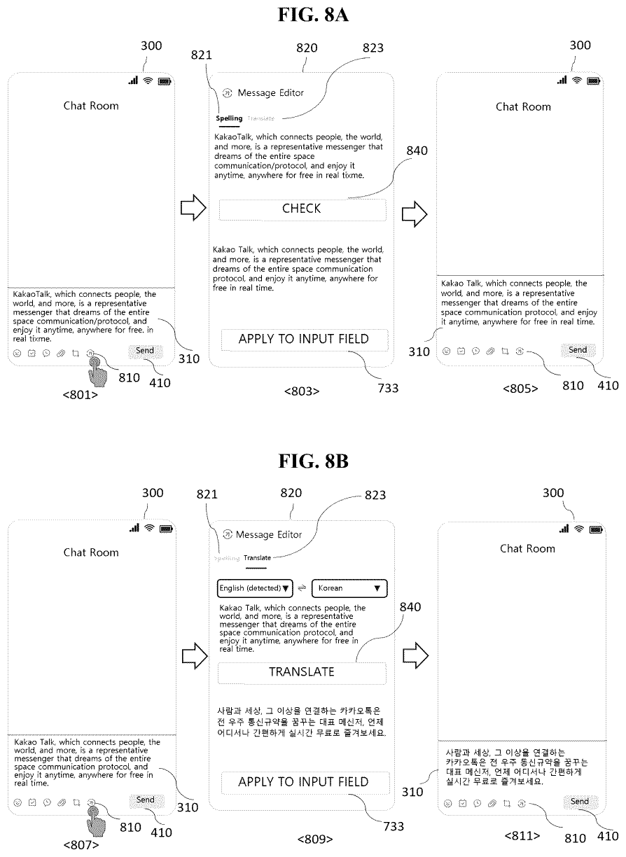

FIGS. 8A and 8B illustrate an example in which the electronic device 100 provides a message change interface according to one embodiment of the present disclosure.

Referring to 801 of FIG. 8A, the electronic device 100 may display a chat room 300 on the screen. The chat room 300 may include an input interface 310 for entering a message, a send interface 410 for sending a message, and a message editor interface 810. For example, the electronic device 100 may receive an input message (e.g., KakaoTalk, which connects people, the world, and more, is a representative messenger that dreams of the entire space communication/protocol, and enjoy it anytime, anywhere for free in real tixme.) through the input interface 310, and then receive an interaction with the message editor interface 810.

Referring to 803 of FIG. 8A, in response to an interaction with the message editor interface 810, the electronic device 100 may display a message editor window 820 on the screen. According to one embodiment, the message editor window 820 may be displayed in the form of a pop-up window on the screen of the electronic device 100. According to another embodiment, the message editor window 820 may be displayed to overlap at least a portion of the chat room 300 displayed on the screen of the electronic device 100.

According to one embodiment, the message editor window 820 may include a spell check interface 821, a translation interface 823, an execution interface 840 for message change, and an apply interface 733.

According to one embodiment, the spell check interface 821 may be an interface that supports a function for correcting spelling errors in an input message. For example, the spell check interface 821 may be an interface corresponding to a first message change interface 331. According to one embodiment, the translation interface 823 may be an interface that supports a function for changing language type information (e.g., Korean, English, Japanese, Arabic, Chinese, etc.) of an input message. For example, the translation interface 823 may be an interface corresponding to a second message change interface 333.

According to one embodiment, the electronic device 100 may display an input message in a message editor window 820 via the input interface 310. In response to receiving an interaction with the execution interface 840 while the spell check interface 821 is activated, the electronic device 100 may display a spelling-corrected message in the message editor window 820. For example, the electronic device 100 may correct an error (e.g., in real tixme) in an input message received through the input interface 310 and display a spelling-corrected message (e.g., in real time).

According to one embodiment, when a spelling error is identified in an input message received through the input interface 310, the electronic device 100 may activate the spell check interface 821 rather than the translation interface 823. The activation of the spell check interface 821 may indicate a state in which, when a selection interaction with the message editor interface 810 is received, a screen associated with the spell check interface 821 is activated and displayed without a separate input from the user.

Referring to 805 of FIG. 8A, in response to receiving an interaction with the apply interface 733, the electronic device 100 may display a spelling-corrected message in the chat room 300. For example, a spelling-corrected message (e.g., Kakao Talk, which connects people, the world, and more, is a representative messenger that dreams of the entire space communication protocol, and enjoy it anytime, anywhere for free in real time.) may be displayed in the chat room 300.

Referring to 807 and 809 of FIG. 8B, in response to an interaction with the message editor interface 810, the electronic device 100 may display the message editor window 820 on the screen.

According to one embodiment, in response to receiving an interaction with the execution interface 840 while the translation interface 823 is activated, the electronic device 100 may display, in the message editor window 820, a message whose language type information has been changed from that of the input message (e.g., Korean, English, Japanese, etc.). For example,, the electronic device 100 may change an English input message, received through the input interface 310, into Korean and display the input message changed into Korean.

According to one embodiment, the electronic device 100 may activate a translation interface 823 rather than the spell check interface 821, based on the type of the chat room participated by the account of the electronic device 100 (e.g., a chat room in which Korean messages are sent and received), language type information (e.g., Korean) of a message previously input by the account of the electronic device 100 (e.g., Korean), or the like. The activation of the translation interface 823 may indicate a state in which, when a selection interaction with the message editor interface 810 is received, a screen associated with the translation interface 823 is activated and displayed without a separate input from the user.

Referring to 811 of FIG. 8B, in response to receiving an interaction with the apply interface 733, the electronic device 100 may display a translated message in the chat room 300. For example, a message translated into Korean (e.g., Korean language message indicating “Kakao Talk, which connects people, the world, and more, is a representative messenger that dreams of the entire space communication protocol, and enjoy it anytime, anywhere for free in real time”) may be displayed in the chat room 300.

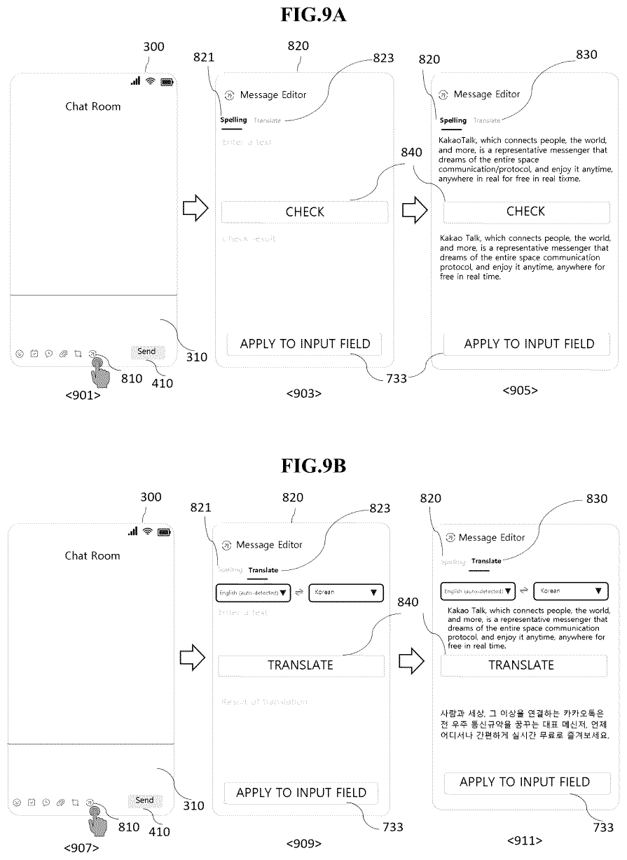

FIGS. 9A and 9B illustrate an example in which the electronic device 100 provides a message change interface according to one embodiment of the present disclosure.

Referring to 901 of FIG. 9A, the electronic device 100 may display a chat room 300 on the screen. The chat room 300 may include an input interface 310 for entering a message, a send interface 410 for sending a message, and a message editor interface 810. According to one embodiment, the electronic device 100 may receive an interaction with the message editor interface 810 without receiving a message through the input interface 310.

Referring to 903 of FIG. 9A, in response to the interaction with the message editor interface 810, the electronic device 100 may display a message editor window 820 on the screen. According to one embodiment, the electronic device 100 may receive input for a message through the message editor window 820.

Referring to 905 of FIG. 9A, the electronic device 100 may receive an input message (e.g., KakaoTalk, which connects people, the world, and more, is a representative messenger that dreams of the entire space communication/protocol, and enjoy it anytime, anywhere for free in real time.). Then, in response to receiving an interaction with an execution interface 840 for message change while a spell check interface 821 is activated, the electronic device 100 may display a spelling-corrected message in the message editor window 820. For example, the electronic device 100 may correct a received message with a spelling error (e.g., in real tixme) through the message editor window 820 and display a spelling-corrected message (e.g., in real time).

Referring to 907 of FIG. 9B, the electronic device 100 may receive an interaction with the message editor interface 810 without receiving a message through the input interface 310.

Referring to 909 of FIG. 9B, in response to the interaction with the message editor interface 810, the electronic device 100 may display the message editor window 820 on the screen. According to one embodiment, the electronic device 100 may receive input for a message through the message editor window 820.

Referring to 911 of FIG. 9B, the electronic device 100 may receive an input message (e.g., KakaoTalk, which connects people, the world, and more, is a representative messenger that dreams of the entire space communication/protocol, and enjoy it anytime, anywhere for free in real time.). Then, in response to receiving an interaction with the execution interface 840 while the translation interface 823 is activated, the electronic device 100 may display a translated message in the message editor window 820. For example, a message translated into Korean (e.g., Korean language message indicating “Kakao Talk, which connects people, the world, and more, is a representative messenger that dreams of the entire space communication protocol, and enjoy it anytime, anywhere for free in real time”) may be displayed in the message editor window 820.

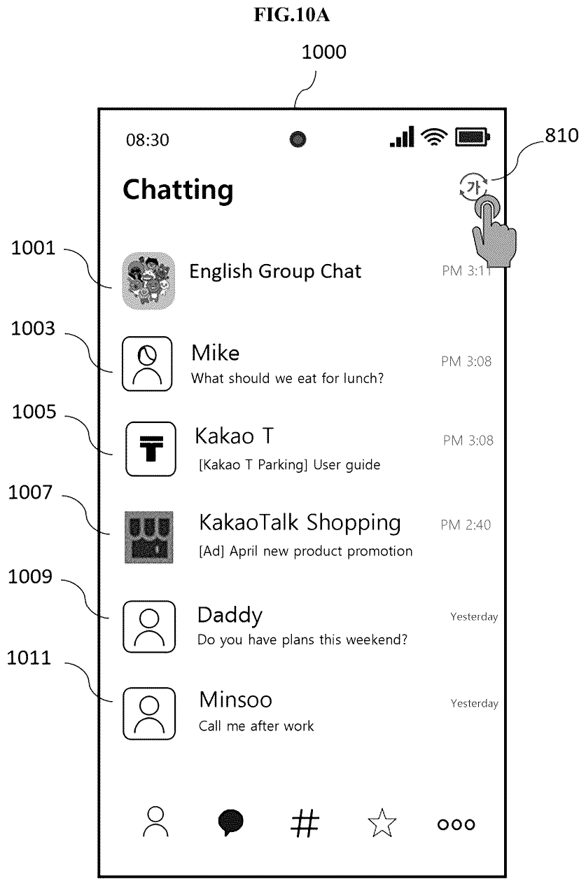

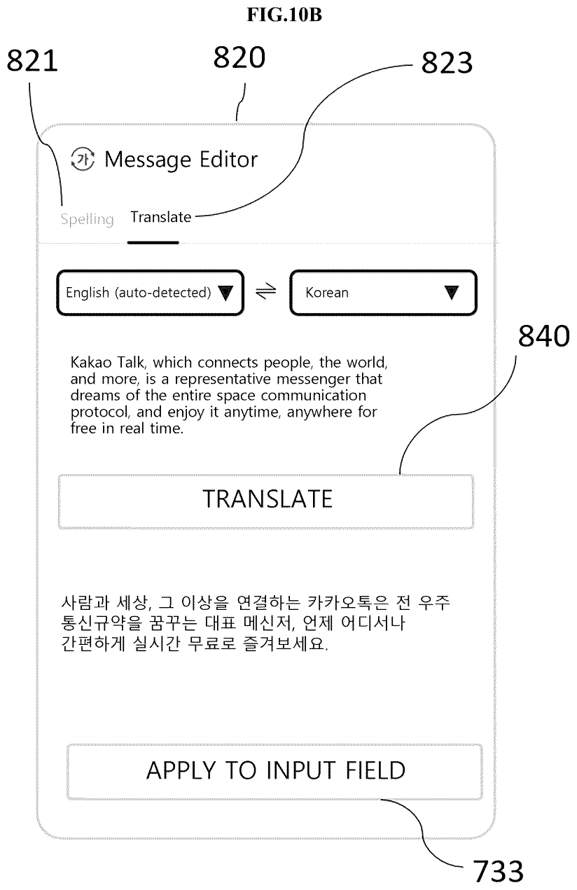

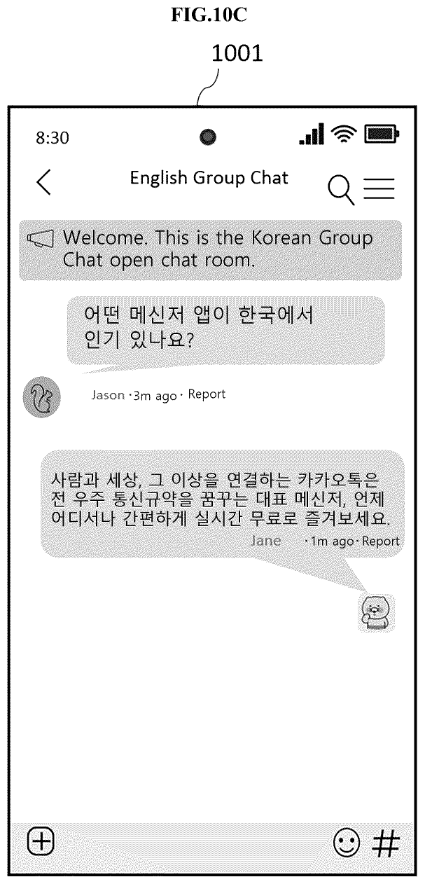

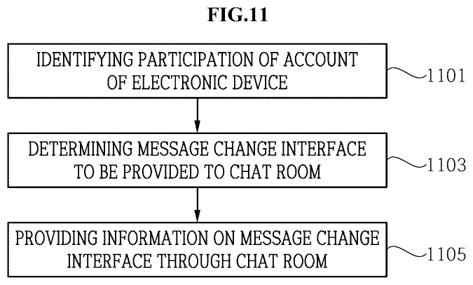

FIGS. 10A to 10C illustrate an example in which the electronic device 100 provides a message change function according to various embodiments of the present disclosure.

Referring to FIG. 10A, the electronic device 100 may display a chat history interface 1000 on the screen. The chat history interface 1000 may include a first chat room 1001, a second chat room 1003, a third chat room 1005, a fourth chat room 1007, a fifth chat room 1009, and a sixth chat room 1011 in which the account of the electronic device 100 is participating. The electronic device 100 may receive an interaction with the message editor interface 810 included in one area of the chat history interface 1000.

Referring to FIG. 10B, in response to receiving an interaction with a message editor interface 810, the electronic device 100 may display a message editor window 820 on the screen. According to one embodiment, the message editor window 820 may include a spell check interface 821, a translation interface 823, an execution interface 840 for message change, and an apply interface 733.

According to one embodiment, in response to receiving an interaction with an execution interface 840 for message change while the translation interface 823 is activated, the electronic device 100 may display, in the message editor window 820, a message in which language type information (e.g., Korean, English, Japanese, etc.) of the message has been changed. For example, the electronic device 100 may change an English message, received through the input interface 310, into Korean and display the message changed into Korean.

According to one embodiment, in response to receiving an interaction with the apply interface 733, the electronic device 100 may display on the screen an interface that allows selection of a chat room to which the changed message will be sent. For example, when receiving an interaction with the apply interface 733, the electronic device 100 may display, on the screen, an interface for selecting a chat room into which a translated message will be sent among the first to sixth chat rooms 1001 to 1011.

According to another embodiment, in response to receiving an interaction with the apply interface 733, the electronic device 100 may display, on the screen, an interface for selecting an account of another electronic device to which the changed message will be sent. For example, in response to receiving an interaction with the apply interface 733, the electronic device 100 may display, on the screen, an interface for selecting which account of another electronic device (e.g., a second account, a third account, a fourth account, etc.) a translated message will be sent.

According to another additional embodiment, when language type information (e.g., Korean, English, Japanese, etc.) of the message is changed, the electronic device 100 may determine the first chat room 1001 including foreign language type information (e.g., Korean) among the first to sixth chat rooms 1001 to 1011 as the chat room to which a translated message will be sent.

Referring to FIG. 10C, the electronic device 100 may send a translated message to the first chat room 1001. For example, the electronic device 100 may send a translated message (e.g., Korean language message indicating “Kakao Talk, which connects people, the world, and more, is a representative messenger that dreams of the entire space communication protocol, and enjoy it anytime, anywhere for free in real time”) to the first chat room 1001.

FIG. 11 illustrates a flowchart showing how the server 200 of the present disclosure provides a message change interface.

In operation 1101, the server 200 may identify the participation of an account of the electronic device 100 in a chat room. According to various embodiments, the server 200 may identify the number of chat rooms in which the account of the electronic device 100 is participating, the types of the chat rooms, other accounts of other terminals participating in the chat rooms, etc.

In operation 1103, the server 200 may determine a message change interface to be provided to a chat room. The message change interface may be determined based on at least one piece of information from among information on the chat room and information associated with an input message of the electronic device when the at least one piece of the information satisfies a preset criterion.

According to one embodiment, the information on the chat room may include at least one of (i) language type information (e.g., Korean, English, Chinese, etc.) of messages sent and received through the chat room and (ii) spelling error information of such messages. According to one embodiment, the information associated with the input message of the electronic device 100 may include at least one of (i) language type information of the input message (e.g., Korean, English, Japanese, etc.), (ii) spelling error information of messages sent and received through a chat room (e.g., spelling error information of a message sent by the electronic device 100), or (iii) keyword information included in the input message (e.g., #translation, #spelling, #tone, etc.).

According to one embodiment, since the message change interface is determined based on information on a chat room and/or information associated with an input message of the electronic device 100, different message change interfaces may be determined depending on the type of the chat room in which the account of the electronic device 100 participates and/or the input message of the account. For example, the type of a message change interface provided in a first chat room in which the account of the electronic device 100 participates may be different from the type of a message change interface provided in a second chat room. In another example, the server 200 may provide a message change interface providing a translation function and/or a message change interface providing a spelling correction function, depending on the input message of the account of the electronic device 100.

According to one embodiment, when both the information on the chat room and the information associated with the input message satisfy a preset criterion, the server 200 may determine a plurality of message change interfaces to be provided for the chat room. For example, when language type information of messages sent and received through a chat room corresponds to Korean and spelling errors in the user's input message satisfies a preset spelling error rate (e.g., 30%, 50%, 70%, etc.), the server 200 may determine a first message change interface, which provides a translation function (e.g., English-Korean translation), and a second message change interface, which provides a spelling correction function, to be provided for the chat room.

According to another embodiment, when both the information on the chat room and information associated with the input message satisfy a preset criterion, the server 200 may provide only one message change interface among a plurality of message change interfaces corresponding to the preset criterion, based on a preset priority (e.g., translation set as the highest priority, spelling correction set as the highest priority, etc.). For example, when language type information of messages sent and received through a chat room corresponds to a language other than Korean (e.g., Japanese, Spanish, Chinese, etc.) and the preset spelling error rate is 30% or higher, the server 200 may give the translation function the highest priority and determine the first message change interface, which provides the translation function, to be provided for the chat room.

In operation 1105, the server 200 may provide information on the message change interface through the chat room. In one embodiment, the server 200 may provide a related functionality or user interface to enable a message change interface to be provided through the chat room.

According to various embodiments, the server 200 may provide a plurality of message change interfaces, each corresponding to a different function for changing an input message, through the chat room. For example, the server 200 may provide a related functionality or user interface to display a first message change interface and a second interface in a chat room.

According to one embodiment, the server 200 may provide, among a plurality of message change interfaces, a message change interface associated with at least one piece of information satisfying a preset criterion such that the message change interface is displayed in a manner distinguishable from other message change interfaces. For example, when a message in a foreign language (e.g., Korean, Japanese, etc.) is received in a chat room, the server 200 may provide a related functionality or user interface such that a message change interface providing a translation function is displayed in a manner distinguishable from a message change interface providing the spelling correction function.

According to various embodiments, the server 200 may determine a degree of message change based on at least one of (i) language type information of messages sent and received through the chat room and (ii) tone information of such messages. When the server 200 receives an interaction with the message change interface, the server 200 may perform message change based on the determined degree of message change.

For example, when messages sent and received through the first chat room include a friendly tone, the server 200 may maintain the tone of the original message while partially correcting spelling errors in the original message. The friendly tone indicates the tone of an informal message, which is polite without using formal language. In another example, when messages sent and received through the second chat room include a formal tone, the server 200 may completely correct the spelling errors of the original message and change the tone of the original message to the formal tone.

The present disclosure may provide various technical effects and innovations. For example, the present disclosure may provide a more customized message change interface depending on a chat room. Accordingly, a more customized communication experience may be provided to accounts participating in the chat room.

In addition, the present disclosure may provide a customized message change interface based on a message input by the user. Accordingly, a more customized communication experience may be provided to an account which has entered a message.

In addition, when a message change interface is provided, it is possible to save data resources and reduce power consumption of the electronic device and server load by processing related data in a systematic and structured manner without the user's intervention. Furthermore, the provision of the customized message change interface and the processing of associated data as described above may contribute to saving computing resources (e.g., terminals, servers, etc.).

The computer-readable recording medium may include a hard disk, a floppy disk, magnetic media (e.g., magnetic tape), optical media (e.g., compact disc read-only memory (CD-ROM), digital versatile disc (DVD)), magneto-optical media (e.g., floptical disk), and hardware devices such as read-only memory (ROM), random access memory (RAM), or flash memory. In addition, program instructions may include not only machine language code, such as that produced by a compiler, but also high-level language code that may be executed by a computer using an interpreter or the like. The hardware device described above may be configured to operate as one or more software modules to perform the operations of the various embodiments described above, and vice versa is also possible.

The technical features disclosed in the respective embodiments of the present invention are not limited to those embodiments alone, and, unless they are mutually incompatible, the technical features disclosed in one embodiment may be combined and applied to other embodiments. It will also be understood by those skilled in the art that any disjunctive word and/or phrase appearing in the detailed description, the claims, or the drawings, indicating two or more alternative terms, should be understood to include the possibility of one term, any one of the terms, or two or more of the terms. For example, the phrase “A or B” is to be interpreted to include “A”, “B”, or both “A and B.” In addition, as used herein, the term “each” may, in addition to its ordinary meaning, be understood to encompass any subset of the elements to which the term “each” applies. Furthermore, the phrase “at least one of X, Y, or Z” is to be interpreted to mean one or more of X, Y, and Z, unless the context clearly indicates otherwise. Thus, such phraseology is not intended to imply that a particular embodiment must necessarily include at least one of X, at least one of Y, and at least one of Z.

Therefore, although each embodiment focuses on its own technical features, each technical feature may be applied in combination with one another as long as they are not mutually incompatible.

The present disclosure is not limited to the above-described embodiments and the accompanying drawings, and various modifications and variations may be made by those skilled in the art to which the present disclosure pertains. Therefore, the scope of the present disclosure should be defined not only by the claims of this specification but also by equivalents thereof.

What is claimed is:

1. A method for providing a message change interface by an electronic device, comprising:
receiving an input message through a chat room; and
providing a message change interface through the chat room, the message change interface being determined based on at least one piece of information from among information on the chat room and information associated with the input message when the at least one piece of information satisfies a preset criterion,
wherein providing the message change interface through the chat room comprises:
displaying a plurality of message change interfaces respectively corresponding to a plurality of functions for changing the input message through the chat room; and
displaying, among the plurality of message change interfaces, a message change interface associated with at least one piece of information
satisfying a preset criterion such that the message change interface is displayed in a manner distinguishable from other message change interfaces.

2. The method of claim 1, wherein the message change interface provides at least one of a spell check function for the input message or a translation function for the input message.

3. The method of claim 1, wherein providing the message change interface through the chat room comprises displaying the message change interface in response to receiving an input message through the chat room.

4. The method of claim 1, wherein the information on the chat room comprises at least one of (i) language type information of messages sent and received through the chat room or (ii) spelling error information of the messages sent and received through the chat room.

5. The method of claim 1, wherein the information on the chat room comprises at least one of (i) language type information of messages sent and received through the chat room or (ii) spelling error information of a message sent by the electronic device among the messages sent and received through the chat room.

6. The method of claim 1, wherein the information associated with the input message comprises at least one of (i) the language type information of the input message, (ii) spelling error information of the input message, or (iii) keyword information of the input message.

7. The method of claim 1, further comprising, in response to receiving an interaction with the message change interface, displaying the changed input message through the chat room.

8. The method of claim 1, further comprising, in response to receiving an interaction with the message change interface, displaying a preview interface associated with a changed version of the input message on the chat room.

9. The method of claim 1, wherein providing the message change interface through the chat room comprises displaying the message change interface in response to receiving an interaction with a menu switching interface displayed in one area of the chat room.

10. A method for providing a message change interface by a server, comprising:
identifying participation of an account of an electronic device in a chat room;
determining a message change interface to be provided in the chat room, the message change interface being determined based on at least one piece of information from among information on the chat room and information associated with an input message of the electronic device when the at least one piece of information satisfies a preset criterion; and
providing information on the message change interface through the chat room,
wherein providing the information on the message change interface through the chat room comprises:
providing, through the chat room, a plurality of message change interfaces respectively corresponding to a plurality of functions for changing the input message; and
providing, among the plurality of message change interfaces, a message change interface associated with at least one piece of information satisfying a preset criterion such that the message change interface is displayed in a manner distinguishable from other message change interfaces.

11. The method of claim 10, wherein the message change interface provides at least one of a spell check function for the input message or a translation function for the input message.

12. The method of claim 10, wherein the information on the chat room comprises at least one of (i) language type information of messages sent and received through the chat room or (ii) spelling error information of the messages sent and received through the chat room.

13. The method of claim 10, wherein the information on the chat room comprises at least one of (i) language type information of messages sent and received through the chat room or (ii) spelling error information of a message sent by the electronic device among the messages sent and received through the chat room.

14. The method of claim 10, wherein the information associated with the input message of the electronic device comprises at least one of (i) the language type information of the input message, (ii) spelling error information of the input message, or (iii) keyword information of the input message.

15. The method of claim 10, further comprising performing a change on the input message in response to receiving an interaction with the message change interface.

16. The method of claim 15, wherein performing the change on the input message in response to receiving the interaction with the message change interface comprises:
determining a degree of change of the input message based on at least one of the language type information or tone information of messages sent and received through the chat room; and
in response to receiving an interaction with the message change interface, performing a change on the input message based on the determined degree of change of the message.

17. A server for providing a message change interface, comprising:
a memory storing instructions, and
a processor configured to execute the instructions to:
identify participation of an account of an electronic device in a chat room;
determine a message change interface to be provided in the chat room, the message change interface being determined based on at least one piece of information from among information on the chat room and information associated with an input message of the electronic device when the at least one piece of information satisfies a preset criterion; and
provide information on the message change interface through the chat room by:
providing, through the chat room, a plurality of message change interfaces respectively corresponding to a plurality of functions for changing the input message; and
providing, among the plurality of message change interfaces, a message change interface associated with at least one piece of information satisfying a preset criterion such that the message change interface is displayed in a manner distinguishable from other message change interfaces.
